(19) United States
(12) Patent Application Publication
(10) Pub. No.: US 2012/0180480 A1
(43) Pub. Date: Jul. 19, 2012

(54) Hybrid turbocharger system with brake energy revovery

(76) Inventor: Davorin Kapich, Carlsbad, CA (US)

(21) Appl. No.: 13/374,862

(22) Filed: Jan. 18, 2012

Related U.S. Application Data
(63) Continuation-in-part of application No. 12/930,870, filed on Jan. 19, 2011.
(60) Provisional application No. 61/461,564, filed on Jan. 20, 2011.

(51) Int. Cl. F02B 37/04

(52) U.S. Cl. 60/606

(57) ABSTRACT

A hybrid hydraulic turbocharger system for internal combustion engines. The turbocharger system includes a hydraulic pump motor in mechanical communication with said engine drive shaft. A hybrid turbocharger unit includes an engine exhaust gas turbine driving a compressor, a hydraulic turbine and a hydraulic pump, all mounted on said turbocharger shaft. The hydraulic pump motor functions as a hydraulic pump driven by the drive shaft of the engine to provide additional boost to the turbocharger unit at low engine speeds and functions as a hydraulic motor driven by the turbocharger pump to provide additional torque to the engine drive shaft high engine speeds. Additionally, this system provides for brake energy recovery by storing the energy absorbed during the breaking cycle and releasing it back to the pump motor when required during the subsequent acceleration cycle.

### CROSS REFERENCE TO RELATED APPLICATIONS

This application claims the benefit of Provisional Application Ser. No. 61/461,564 filed Jan. 20, 2011 and is a continuation in part of Ser. No. 12/930,870 filed Jan. 19, 2011.

### FIELD ON THE INVENTION

The present invention relates to modern automotive vehicles and in particular to systems such as turbocharger systems for improving efficiency and performance.

### BACKGROUND OF THE INVENTION

Conventional turbochargers use engine exhaust power to drive a turbocharger exhaust turbine which powers an air compressor that supplies high pressure combustion air to the engine. For modern automotive vehicles there is a need for higher specific engine power, lower fuel consumption and lower exhaust emissions. These are met with smaller higher speed engines that require high boost achievable over wide engine speed ranges. A specific need for modern high speed engines is a higher engine torque in the low engine speed range to improve vehicle acceleration. This usually results in an excess of the engine exhaust energy at higher engine speeds. To prevent the turbocharger over-speed and over-pressure, this is currently handled by “waste-gating” substantial portions of the engine exhaust flow which represents a waste of fuel. The wasted energy going out the tail pipe in the form of exhaust gas flow is estimated to be on the order of up to 20% in compact engines.

Some significant improvements are provided with electric-internal combustion hybrid vehicles which include an electric motor-generator and a high energy battery system that converts braking energy into stored electric energy to assist the internal combustion engine. The problem is the motor-generator and the battery system adds considerably to the cost and weight of the vehicle and occupies substantial space in the vehicle.

Applicant was granted on Jul. 20, 1999 U.S. Pat. No. 5,924,286 describing a very high speed radial inflow hydraulic turbine incorporated in a basic turbocharger design to produce a hydraulic supercharger system. The hydraulic turbine assists the turbocharger gas turbine for purpose of increasing engine torque and improving vehicle acceleration at low engine speeds. That patent is incorporated by reference herein especially the turbocharger hydraulic assist turbine shown as part 61 in FIG. 14 of that patent.

While the hydraulic turbine improved performance at low speed performance, there still exists a great need for making use of wasted exhaust flow and improvement in engine fuel consumption at high engine speeds and there is also a need for a lighter, smaller, less expensive alternative to the hybrid vehicle for recovering braking energy.

### SUMMARY OF THE INVENTION

This invention provides a hybrid hydraulic turbocharger system for internal combustion engines. The turbocharger system includes a hydraulic pump motor in mechanical communication with said engine drive shaft. The hydraulic pump motor functions as a hydraulic pump driven by the drive shaft of the engine at low engine speeds and functions as a hydraulic motor to provide additional torque to said drive shaft high engine speeds. A hybrid turbocharger unit includes an engine exhaust gas turbine driving a compressor, a hydraulic turbine and a second hydraulic pump, all mounted on said turbocharger shaft. The compressor, driven by exhaust gases produced by said engine and by high pressure hydraulic fluid produced by the hydraulic pump motor at high engine speeds, drives air into the internal combustion engine. The turbocharger shaft provides power to drive a high pressure hydraulic pump impeller which in turn provides high pressure hydraulic flow into the hydraulic pump motor producing additional torque to said engine drive shaft at high engine speeds. The hydraulic turbine driven by high pressure hydraulic fluid from said hydraulic pump portion of the pump motor provides additional boost to the turbocharger unit driving additional air into the engine for acceleration at low engine speeds. Additionally, this system provides for brake energy recovery by storing the energy absorbed during the breaking cycle and releasing it when required during the subsequent acceleration cycle.

Preferred embodiment include a high pressure hydraulic accumulator in hydraulic communication with the hydraulic pump motor and adapted to accumulate high pressure hydraulic fluid pumped by the hydraulic pump motor during vehicle braking cycles and to supply the high pressure fluid back to the hydraulic pump motor during vehicle acceleration cycles to add torque to the drive shaft recovering a portion of vehicle kinetic energy loss during the braking cycles. Applicant estimates that the efficiency of this brake energy recovery will be about the same or better than the brake energy recovery efficiency of electric hybrid vehicles currently on the market, but at much lower cost, much less weight and with much more compact components.

Preferred embodiments of this invention utilize plastic-metal radial turbine wheels in which the wheels other than blades are jointly anchored within metal containing wheel as described in U.S. Pat. No. 5,924,286.

### BRIEF DESCRIPTION OF THE DRAWINGS

FIG. 1 shows hybrid turbocharger-engine overall system.

FIG. 2 shows preferred embodiment of integrated hydraulic turbine-power recovery pump hybrid design.

FIG. 3 shows simplified schematics of the novel hybrid hydraulic turbine-pump system.

FIG. 4 is a cross sectional drawing showing a preferred embodiment of the very high speed hybrid turbocharger.

FIGS. 5A and 5B show performance of the fixed displacement hydraulic pump motor that is either recovering excess power from the turbocharger or is assisting in accelerating the turbocharger when needed.

FIG. 6 shows simplified schematics of the overall hybrid turbocharger-brake energy recovery system.

### DETAILED DESCRIPTION OF PREFERRED EMBODIMENTS

### First Preferred Embodiments

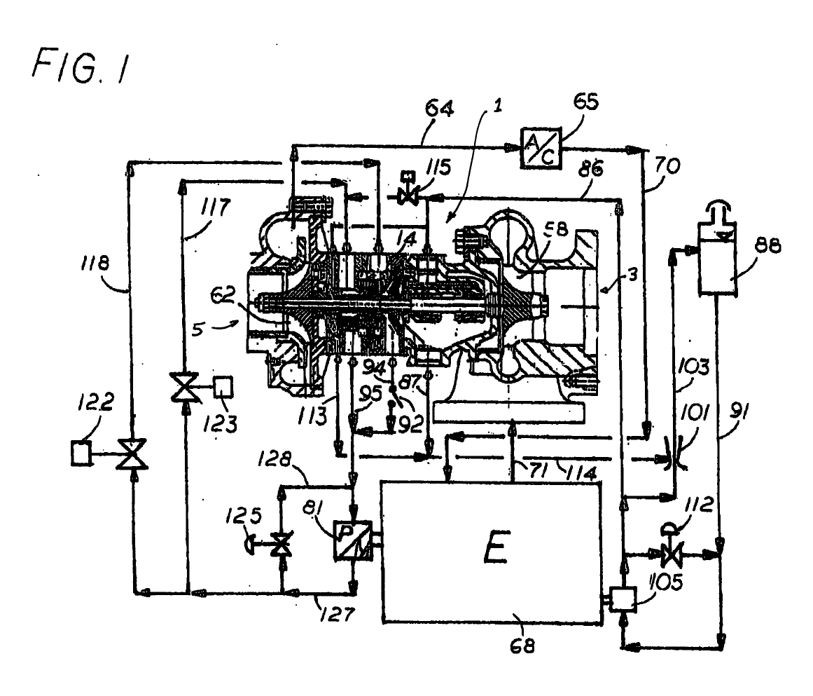

A first preferred embodiment of the present invention can be described by reference to the figures. FIG. 1 shows some of the important features of the present invention. A hydraulic turbine-pump hybrid turbocharger is shown at 1 in FIG. 1. Turbocharger 1 is driven primarily by engine exhaust line 71 from engine 68. The exhaust gases from the engine are directed through blades 58 of the exhaust gas turbine portion of turbocharger 1. Exhaust gases exit the turbocharger as shown at 3 in FIG. 1. Environmental air is drawn into the compressor portion of turbocharger as shown at 5 and is compressed by compressor blades 62. Compressed air is directed to air cooler 65 via pipe 64 and cooled compressed air is directed into engine 68 via pipe 70. The above portion of the turbocharger is all conventional.

Constant displacement hydraulic pump motor 81 is passing the hydraulic flow at rate proportional to the engine RPM. With both turbine inlet valve 123 and pump inlet valve 122 closed, the hydraulic bypass valve 125 is fully open bypassing all the hydraulic pump/motor 81 flow via bypass line 128 thus unloading the pump motor 81. In that mode there is no power inputted or extracted from the turbocharger shaft. Friction losses from inactive 13.5 mm diameter hydraulic turbine blades 11 and 14.5 mm diameter hydraulic pump blades 12 is projected to be minimal because most of the hydraulic fluid is centrifuged out of both wheels.

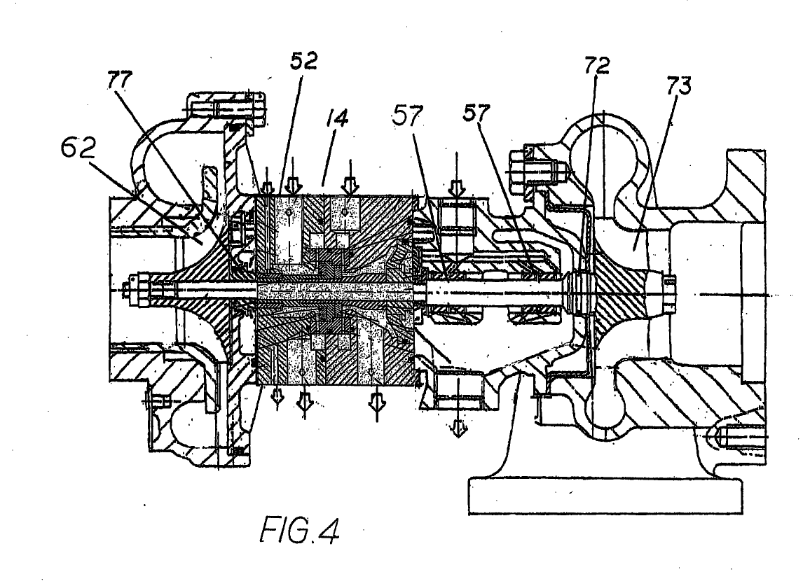

During the entire engine operation the lubrication pump 105 supplies hydraulic fluid (oil) to turbocharger bearings via line 86 shown on FIG. 1. Two turbocharger bearings 57 and the compressor side bearing 52 shown on FIG. 4 are being supplied with oil by line 86. Oil drain lines 87 and 113 provide for drain flow out the three bearings and into the bearings venturi throat 101 where the low suction pressure created by additional flow from lubrication pump 105 pumps all bearings drain flow into oil tank 88. Bearing drain flow may contain small amounts of exhaust gas and compressor air that leaks through turbine shaft seal 72 and compressor shaft seal 77 shown in FIG. 4. Oil tank 88 is vented at atmospheric pressure into a line connected to the air compressor inlet 5 to eliminate any gas emission.

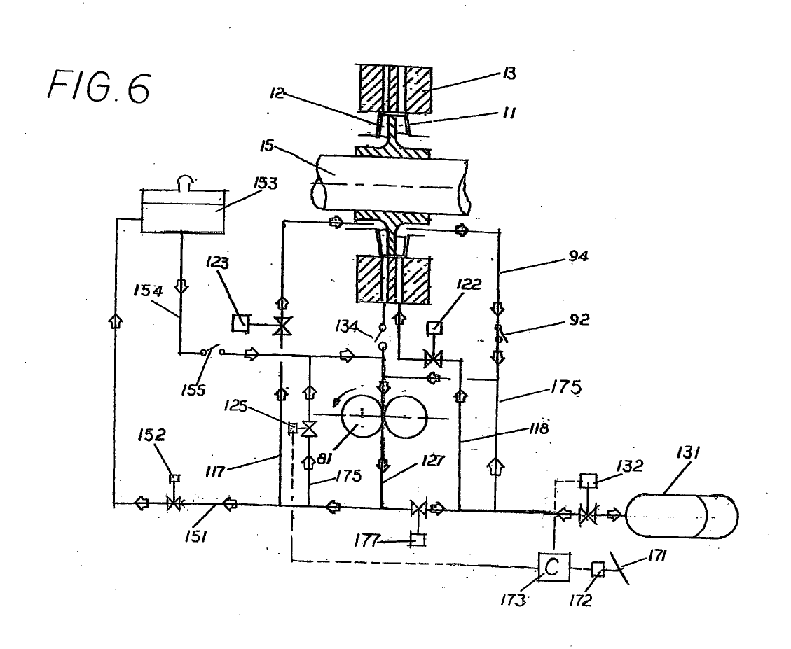

During the vehicle breaking cycle the hydraulic pump and turbine portions of the turbocharger are hydraulically isolated by shutting hydraulic valves 123 and 122 and by action of hydraulic check valves 92 and 134 shown in FIG. 6. Hydraulic energy is stored in accumulator 131 by pumping action of the hydraulic pump/motor 81 that at the same time provides breaking action for the vehicle. Accumulator valve 132 provides for control of degree of breaking action. At the end of the breaking cycle the hydraulic pump/motor 81 is fully unloaded by opening bypass valve 125. Stored energy in accumulator 131 is released during the acceleration cycle by fully or partially opening of the accumulator valve 132 providing high pressure hydraulic flow into the hydraulic pump/motor 81 that is directly coupled to the engine 68 shown in FIG. 1. During the acceleration cycle hydraulic turbine inlet valve 122 can be partially or fully open as needed to assist the turbocharger turbine 51 in providing required engine boost produced by the turbocharger compressor 62 shown in FIG. 1.

### Hydraulic Pump and Turbine Portions of Hybrid Turbocharger

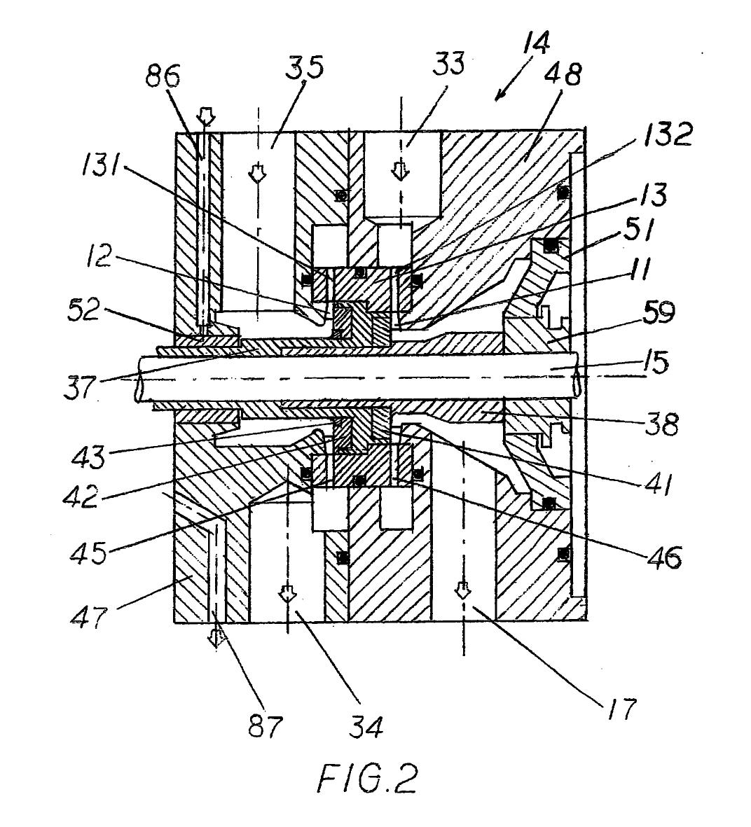

FIG. 2 is a cross sectional drawing of an enlarged portion 14 of the hybrid turbocharger 1 shown in FIG. 1. FIG. 2 shows in detail the hydraulic turbine portion (on the right) and the hydraulic pump portion (on the left). The hydraulic turbine-pump assembly 14 incorporates hydraulic turbine blades 11 solidly attached to hydraulic turbine wheel 41 and hydraulic pump blades 12 solidly attached to hydraulic pump wheel 42. Both plastic wheels 41 and 42 are solidly anchored inside pump side steel rotor 37 and turbine side steel rotor 38 to form an integral rotor pump-turbine assembly. Steel ring 43 serves as a retaining ring to hydraulic pump wheel 42. Turbine-pump stator ring 13 containing pump stator passages 131 and turbine nozzles 132 is contained inside hydraulic turbine housing 48 and hydraulic pump housing 47. Pump side journal bearing 52 is lubricated via oil passage 86 and drain passage 87. Pump inlet passage 35 and pump discharge passage 34 are contained in the hydraulic pump housing 47 and turbine inlet passage 33 and turbine discharge passage 17 are contained in the hydraulic turbine housing 48. Turbine shaft seal 59 and cover ring 51 seal the turbine discharge passage 17.

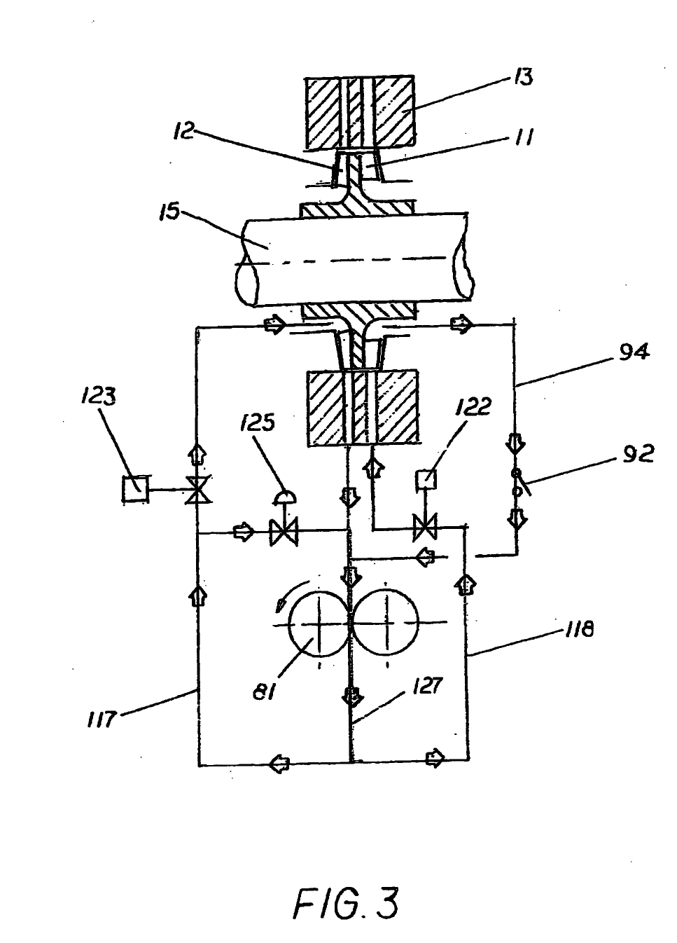

Shown in FIG. 3 is a simplified schematic of the hydraulic turbine-pump system of the present invention. Hydraulic gear pump motor 81 is directly coupled to the engine shaft and provides hydraulic power to hybrid turbocharger turbine blades 11 via turbine inlet line 118 when turbine inlet valve 122 opens and pump inlet valve 123 closes. Alternatively, when turbine inlet valve 122 closes and pump inlet valve 123 opens; the pump blades 12 of hybrid turbocharger 1 provide high pressure hydraulic flow to the hydraulic gear pump-motor 81 that in turn transmits power to the engine shaft as shown in FIG. 1. High speed hydraulic centrifugal pump blades 12 are part of the same wheel assembly with hydraulic turbine blades 11. As explained above, turbocharger shaft 15 can be driven by turbine blades 11 when additional turbocharger power is required at low engine speeds or the turbocharger shaft can alternatively drive centrifugal pump blades 12 when excess turbocharger power is available at higher engine speeds.

### Modes of Operation

There are three principal modes of operation of the present invention. One principal mode is the hybrid turbocharger boost mode to provide boost to the turbocharger at low engine speeds where energy from the engine drive shaft produces high pressure fluid to boost the turbocharger. The second mode is the engine assist mode where the hybrid turbocharger provides high pressure fluid to the turbine portion of the pump motor 81 to provide additional torque to the engine drive shaft utilizing excess energy in the engine exhaust gas flow. In a third mode, the braking energy recovery mode, high pressure fluid is driven into and stored an accumulator during braking actions by the hybrid turbocharger and this high pressure fluid is during a subsequent acceleration directed to the turbine portion of the pump motor 81 to provide additional torque to the engine drive shaft.

### Hybrid Turbocharger Boost Mode

As shown in FIG. 3 in the hybrid turbocharger boost mode turbine, inlet valve 122 is open pump inlet valve 123 is closed and bypass valve 125 is closed so the output of hydraulic pump-motor is directed through pipe 118 to the hydraulic turbine portion hybrid turbocharger 1 to charge additional compressed air into the engine to provide additional boost to the engine during low speed acceleration. For engines between 1.2 and 1.8 liter displacement a need for this mode of operation is estimated to be during fast vehicle acceleration in the engine speed range between 1000 and 3000 RPM with corresponding turbocharger speed between 90,000 and 120,000 RPM. During the beginning of this mode at estimated 1000 RPM, the hydraulic turbine inlet valve 122 is open and hydraulic pump inlet valve 123 and hydraulic bypass valve 125 are closed. This forces all the hydraulic flow generated by the hydraulic pump/motor 81 to flow via high pressure hydraulic line 117 into the hydraulic turbine inlet port 33 and through hydraulic turbine blades 11 generating required power input into turbocharger shaft 15 shown in FIG. 2. During this mode of operation the hydraulic bypass valve 125 can be modulated from fully closed to fully open position via variable voltage signal. For this application a Model PV72-31 Normally Open Proportional Flow Control Valve is chosen as hydraulic bypass valve 125. This valve is manufactured and marketed by HydraForce, Inc., Lincolnshire, Ill.

As the engine RPM increases the hydraulic flow rate generated by the hydraulic pump/motor 81 increases proportionally to the engine RPM while need for hydraulic turbine assist power gradually decreases to zero toward 3000 RPM range. Hydraulic bypass valve 125 controlled by varying voltage signal gradually opens in response to decreasing voltage control to fully open at about 3000 engine RPM. Hydraulic bypass valve 125 is of the fail open type and with zero voltage input it stays fully open at which point the hydraulic turbine valve 122 closes with pump/motor 81 fully unloaded. Hydraulic turbine 11 is designed to produce up to 8 HP @ 100,000 RPM with hydraulic pump/motor 81 input of 9 GPM at 2100 psig with hydraulic turbine efficiency of approximately 75%.

Following table shows estimated hydraulic system parameters during the hydraulic turbine assist mode using 1.16 cu in/rev pump motor 81:

| | | | | |
|---|---|---|---|---|
| Engine RPM | 1500 | 2000 | 3000 | 4000 |
| Pump/motor RPM | 1818 | 2424 | 3636 | 4848 |
| Pump motor gpm | 8.21 | 10.96 | 16.43 | 21.9 |
| % bypass valve 125 | 0 | 11 | 70 | 100 |
| Hydr. turb. flow gpm | 8.21 | 8.54 | 4.93 | 0 |
| Hydr. turb. P1 psig | 1960 | 2163 | 720 | 0 |
| Hydr. turb. effic. % | 60 | 75 | 40 | 0 |
| Hydr. turb. power HP | 5.75 | 8.1 | 1.1 | 0 |

### Engine Assist Mode

Increase in engine speed above approximately 3000 RPM operating at full throttle causes turbocharger gas turbine 73 to produce power in excess of the air compressor 62 power needed for full engine boost. In standard turbochargers this power excess is handled by the exhaust wastegate valve which essentially dumps the excess exhaust gas flow into the engine exhaust system. In the engine assist mode turbine inlet valve 122 is closed bypass valve 125 is closed and pump inlet valve 123 is open. In order to prevent cavitations in high-speed pump blades 12 the pump inlet passage 35 is pressurized by hydraulic fluid supplied by lubrication pump 105 via open pump inlet pressurization valve 115. A combination of pump blades 12 and pump stator passage 131 produce high pressure hydraulic flow exiting, via pipe 95, of the pump portion of the hybrid turbocharger which drives pump motor 81 providing additional torque to the engine drive shaft.

In preferred embodiments of this invention the turbocharger wastegate valve and the wasted exhaust gas flow has been eliminated by using the excess power to drive via turbocharger shaft a high speed centrifugal pump blades 12 producing high pressure hydraulic flow which via hydraulic pump discharge channel 34 shown in FIG. 2 and high pressure hydraulic line 95 shown in FIG. 1 drives the pump motor 81 that transmits this power into the engine drive shaft via pump motor 81. Before initiation of the power recovery mode hydraulic bypass valve 125 is open and turbine inlet valve 122 and pump inlet valve 123 are closed. In order to prevent cavitation in the high speed hydraulic pump blades 12 the pump inlet passage 35 must be pressurized to approximately 60 to 90 psig which is accomplished by opening pump inlet pressurization valve 115 in sequence with opening pump inlet valve 122 and closing hydraulic bypass valve 125. This allows for lubrication pump 105 to pressurize pump inlet passage 35 via lubrication line 86 which allows hydraulic pump blades 12 to start pumping hydraulic fluid via high pressure hydraulic line 95 into the hydraulic pump motor 81 thus producing mechanical power transmitted to the engine.

Following table shows estimated hydraulic system parameters during the hydraulic pump power recovery mode using 1.16 cu in/rev pump/motor 81:

| | | | |
|---|---|---|---|
| Turbocharger RPM | 140,000 | 150,000 | 160,000 |
| Hydr. flow gpm | 21.5 | 26.3 | 30.5 |
| Hydr. press. psig | 620 | 820 | 980 |
| Hydr. pump eff. % | 60 | 70 | 70 |
| Pump inlet spec. speed | 15,000 | 15,000 | 15,000 |
| Pump inlet press. psia | 53 | 72 | 89 |
| Pump HP | 9.0 | 18.0 | 25.0 |

### Breaking Energy Recovery Mode

FIG. 6 is a simplified schematic showing describing the function of a preferred hybrid turbocharger-brake energy recovery system during the braking energy recovery mode of operation. This system is an expansion of the hydraulic turbine-pump system shown in FIG. 3. During this mode of operation the turbocharger basically does not provide boost into the engine and hydraulic portion of the turbocharger is isolated by shutting valves 123 and 122. As most vehicular breaking systems use hydraulic actuated brakes, when brake pedal 171 is applied the pressure transducer 172 sends a signal to the controller 173 opening accumulator valve 132 and closing the bypass valve 125 and valve 152 leading to the hydraulic storage tank 153. Hydraulic fluid is now free to flow from hydraulic storage tank 153 via line 154 into the inlet of hydraulic pump/motor 81 where the fluid is pressurized and delivered into accumulator 131.

During a subsequent acceleration cycle stored accumulator energy is released by engine control system signal to the controller 173 which opens the accumulator valve 132 allowing for high pressure hydraulic fluid to drive the hydraulic pump/motor 81 increasing the total engine torque. During this cycle valve 152 is open and valve 177 is closed allowing returning hydraulic fluid to flow via lines 175, 127 and 151 back into hydraulic storage tank 153.

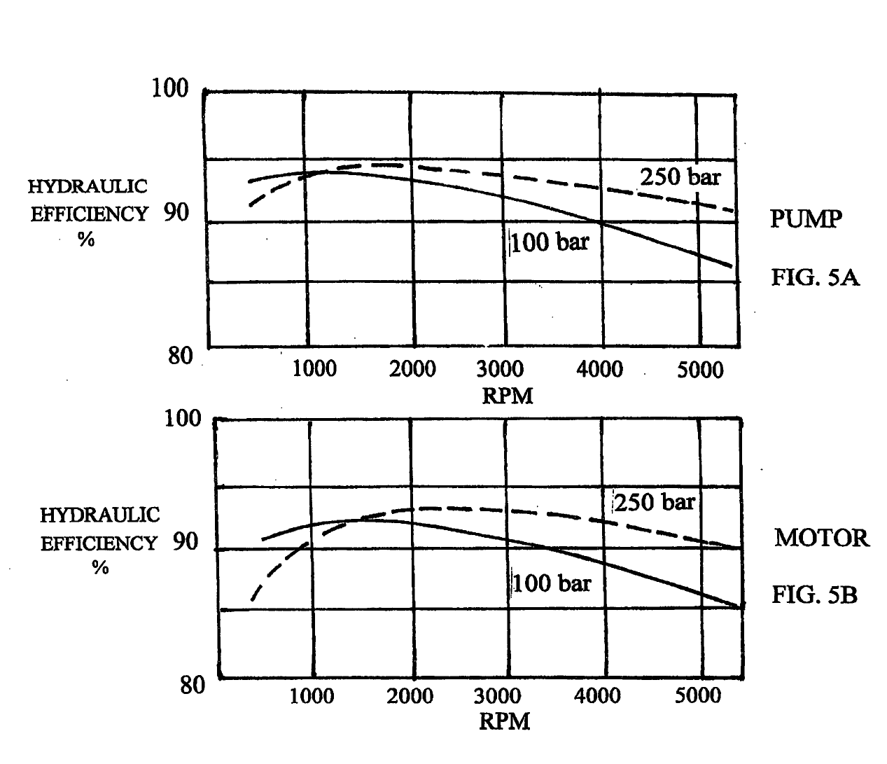

During a typical braking cycle hydraulic fluid is pumped under pressure by pump-motor 81 into accumulator 131. As shown in FIG. 5A, the hydraulic efficiency of pump-motor 81 averages about 90 percent. During the energy recovery cycle (acceleration) the hydraulic efficiency averages about 90 percent. Therefore, the total energy loss during the braking and acceleration cycles is about 20 percent of the total energy absorbed during the total braking and acceleration cycle with an energy recovery of about 80 percent. Applicant expects that this energy recovery will be better than the braking energy recovery of existing hybrid electrical vehicles currently on the market.

Accumulators of the type needed for this application are available from supplier such as Structural Composites Industries with offices in Pomona Calif. and Worthington Cylinder Corporation with offices in Columbus, Ohio. These accumulators come in a variety of sizes. If we design for a braking cycle of about 15 seconds and the pump-motor flow is about 10 gpm at a 3,000 engine rpm, then the accumulator storage capacity would be about 2.5 gallons (i.e. 15/60 minutes×10 gpm=2.5 gallons).

### Components

Hydraulic gear pump-motors are commercially available from Berendsen Hydraulics, Santa Fe Spring, Calif. and other distributors. For automotive engine sizes from 1.2 liter to 1.8 liter a preferred choice is Hydraulic Motor/Pump type Volvo-VOAC Hydraulic Model F11-19 with displacement of 1.16 cu in/rev and overall efficiency for pump or motor operation in excess of 90% as shown in FIGS. 5A and 5B. The F11 Series Pump/Motors are available with displacements from 0.30 to 14.8 cu in/rev that would be able to cover requirements of engines smaller than 1.2 Liter and engines larger than 1.8 Liter. For the T03 to T04 size turbochargers the Hydraulic Turbine Assist mode of operation is projected in the turbocharger speed range between 90,000 and 120,000 RPM and the Power Recovery Pump mode between 130,000 and 190,000 RPM speed range. For engines between 1.2 and 1.8 Liter displacement this would roughly correspond to the engine speed range between 1000 to 3000 RPM for hydraulic turbine assist mode and between 3000 to 6000 RPM for hydraulic pump power recovery mode. Typical accumulator suppliers are referred to in the above section.

### The System Quickly Pays for Itself

Applicant estimates that the cost of the hydraulic turbine pump hybrid turbocharger system in mass production will be about $40 per vehicle. Gasoline mileage should be improved by about 10 percent. At gasoline prices of about $3.50 per gallon, savings, resulting from the improved gasoline mileage, will compensate for the cost of the system in about 5 to 10 months for a typical small automobile. At gasoline prices which can be much higher and for larger vehicles, the savings rate would be substantially greater.

### Potential for Additional Power Recovery

The above table shows potential engine power recovery by using wasted exhaust flow in the hybrid hydraulic pump/turbine turbocharger. Additional power can be recovered by using the turbocharger exhaust heat in a steam turbine power loop or in thermo-electric power systems.

### Variations

The reader should understand that the above descriptions are merely preferred embodiments of the present invention and that many changes could be made without departing from the spirit of the invention. For example the invention can be applied to a great variety and sizes of diesel engines stationary as well as motor vehicle engines. Many features of Applicants prior art patents that have been incorporated by reference herein could be utilized in connection with the present invention. For all of the above reasons the scope of the present invention should be determined by reference to the appended claims and not limited by the specific embodiments described above.

What is claimed is:

1. A hybrid hydraulic turbocharger system for internal combustion engines with an engine drive shaft, said turbocharger system comprising:
A) a hydraulic pump motor in mechanical communication with said engine drive shaft, said hydraulic pump motor being adapted:
1) to function as a first hydraulic pump driven by a drive shaft of said internal combustion engine at low engine speeds and
2) adapted to function as a hydraulic motor to provide additional torque to said drive shaft high engine speeds;
B) a hybrid turbocharger unit having a turbocharger shaft and comprising an engine exhaust gas turbine, a hydraulic turbine and a second hydraulic pump, all mounted on said turbocharger shaft:
1) said compressor being driven by exhaust gases produced by said engine and by high pressure hydraulic fluid produced by said hydraulic pump motor at high engine speeds and adapted to drive air into the internal combustion engine,
2) said second hydraulic pump being adapted to provide high pressure hydraulic fluid to said hydraulic pump motor in order for it to provide additional torque to said engine drive shaft at high engine speeds, and
3) said hydraulic turbine driven by high pressure hydraulic fluid from said first hydraulic pump and adapted to provide additional boost to said turbocharger unit for acceleration at low engine speeds.
C) a high pressure hydraulic accumulator in hydraulic communication with said hydraulic pump motor and adapted to accumulate high pressure hydraulic fluid pumped by said hydraulic pump motor during vehicle braking cycles and to supply the high pressure fluid back to the hydraulic pump motor during vehicle acceleration cycles to add torque to the drive shaft recovering a portion of vehicle kinetic energy loss during the braking cycles.

2. The hybrid turbocharger system as in claim 1 and further comprising a hydraulic fluid bypass system including a bypass valve.

3. The hybrid turbocharger system as in claim 1 and further comprising a control system including a turbocharger pump inlet valve, a turbocharger turbine inlet valve and a bypass valve adapted to control said turbocharger system.

4. The hybrid turbocharger system as in claim 3 wherein for engine acceleration at low engine speeds the bypass valve and the turbocharger pump inlet valve is closed and the hydraulic turbocharger turbine inlet valve is open.

5. The hybrid turbocharger system as in claim 3 wherein at high engine speeds the bypass valve and the turbocharger hydraulic turbine inlet valve are closed and the turbocharger pump inlet valve is open.

6. The hybrid turbocharger system as in claim 1 wherein said turbocharger unit comprises a plurality of turbocharger bearings and said turbocharger system further comprises a bearing lubrication system comprising an oil tank, a lubrication pump providing lubrication oil to said plurality turbocharger bearings and wherein drainage from said plurality is directed through a venturi throat to the oil tank, said oil tank being vented to eliminate any gas emission.

7. The hybrid turbocharger system as in claim 1 wherein said turbocharger system includes a pressurization means for pressurizing the inlet of the second hydraulic pump to prevent cavitations in the second hydraulic pump.
